(19) United States
(12) Patent Application Publication
(10) Pub. No.: US 2009/0011314 A1
(43) Pub. Date: Jan. 8, 2009

(54) Electrode/electrolyte interfaces in solid oxide fuel cells

(76) Inventors: Cheng-Chieh Chao, Palo Alto, CA (US); Timothy P. Holme, Stanford, CA (US); Friedrich B. Prinz, Woodside, CA (US); Masayuki Sugawara, Palo Alto, CA (US)

Correspondence Address: LUMEN PATENT FIRM, INC., 2345 YALE STREET, SECOND FLOOR, PALO ALTO, CA, 94306, US

(21) Appl. No.: 12/217,503

(22) Filed: Jul. 3, 2008

Related U.S. Application Data
(60) Provisional application No. 60/958,551, filed on Jul. 5, 2007.

(51) Int. Cl. H01M 8/10

(52) U.S. Cl. 429/30

(57) ABSTRACT

A solid oxide fuel cell (SOFC) with reduced electrical resistance and greater vacancy density control is provided. The SOFC includes an interfacial layer deposited, preferably by atomic layer deposition (ALD), between an electrode layer and an electrolyte layer. The interfacial layer includes an ion-conductive material. By use of ALD, the interfacial layer can have a very small thickness and can include layered structures of alternating materials. The interfacial layer can also include doping gradient structures of doped ion-conductive materials. Ultra-thin film platinum layers for high current density and cermet layers at the electrode/electrolyte interface are also provided.

### CROSS-REFERENCE TO RELATED APPLICATIONS

This application claims priority from U.S. Provisional Patent Application 60/958,551 filed Jul. 5, 2007, which is incorporated herein by reference.

### FIELD OF THE INVENTION

The invention relates generally to solid oxide fuel cells. More particularly, the present invention relates to electrode/electrolyte interfaces in solid oxide fuel cells.

### BACKGROUND

A solid oxide fuel cell (SOFC) operates by using a solid oxide as an electrolyte. Generally for SOFCs, reduction of oxygen occurs at the positive electrode, referred to as the cathode, oxygen ions are transported through the electrolyte, and oxidation of a fuel gas occurs at the negative electrode, referred to as the anode. SOFCs can be used for a wide variety of applications, including transportation. However, existing SOFCs face many difficulties, primarily due to high operating temperatures. Difficulties with elevated operating temperatures include unreliability of associated components and equipment.

The power density of SOFCs is determined, at least in part, by the electrical resistances in many structural components of the fuel cell, including the interfacial regions. Improvement of the power density of a SOFC could allow for reduced operating temperatures. The SOFC performance is limited by many factors, including mobility of the charge carriers and vacancy densities in or near the electrolyte. Particularly, near the cathode/electrolyte interface, vacancies are required to drive the oxygen ions away after oxygen reduction. However, controlling the vacancy densities can be a difficult task.

Furthermore, existing SOFCs typically have long gas diffusion paths. The long diffusion paths prevent the SOFCs from operating at high current density, thus further decreasing the fuel cell performance.

The present invention addresses at least the difficult problems of solid oxide fuel cell performance and advances the art with interfacial layers for SOFCs.

### SUMMARY OF THE INVENTION

The present invention is directed to a solid oxide fuel cell (SOFC) including an interfacial layer deposited between one or more electrode layers and an electrolyte layer. The electrode layers include a cathode layer and an anode layer. The interfacial layer includes an ion-conductive material, such as zirconia-based oxides, including yttria-stabilized zirconia (YSZ) and scandia-stabilized zirconia (ScSZ). In addition, the interfacial layer can include ceria-based oxides, such as gadolinia-doped ceria (GDC), yttria-doped ceria (YDC), samaria-doped ceria (SDC), or other ion oxide conductors. It is important to note that the thickness of the interfacial layer ranges from about 1 angstrom to about 50 nm, preferably from about 1 angstrom to about 10 angstroms. It is also important to note that the interfacial layer is deposited by atomic layer deposition (ALD).

In a preferred embodiment, the interfacial layer is positioned between the cathode layer and the electrolyte layer. The electrolyte and interfacial layers include a doped ion-conductive material, where the doping of the doped ion-conductive oxide material of the interfacial layer is greater than the doping of the doped ion-conductive oxide material of the electrolyte layer. Particularly, the doped ion-conductive oxide material can include YSZ, where the doping of the YSZ of the electrolyte layer is about 8% yttria and the doping of the YSZ of the interfacial layer ranges from about 8% yttria to about 20% yttria.

In an embodiment of the SOFC of the present invention, an anode/electrolyte interfacial layer is deposited between the anode layer and the electrolyte layer. The anode/electrolyte interfacial layer can also include a doped ion-conductive oxide material, where the doping of the doped ion-conductive material of the anode/electrolyte layer is less than the doping of the doped ion-conductive material of the electrolyte layer. For example, the anode/electrolyte interfacial layer can include YSZ with a doping ranging from about 0.1% yttria to about 8% yttria.

The present invention is also directed to a SOFC with an interfacial layer that includes one or more first material layers and one or more second material layers, where the first and second material layers are alternately deposited between the electrolyte layer and one of the electrode layers. In a preferred embodiment, the first and second material layers include zirconia and yttria, respectively. The thickness of each of the first material layers can be greater than the thickness of each of the second material layers. The thickness of the one or more material layers can be uniform or the thickness of each of the material layers can depend on the position of the same of the material layers. In a preferred embodiment, the thickness of the first material layers decreases with the distance away from the electrolyte layer. Alternatively or additionally, the thickness of the second material layers increases with the distance away from the electrolyte layer. Opposite dependence on distance away from the electrolyte layer can also be applied.

In another embodiment, the SOFC includes a first ultra-thin film platinum layer positioned between the interfacial layer and one of the electrodes. Other platinum layers can also be included, such as a second ultra-thin film platinum layer positioned between the electrolyte layer and another of the electrodes. In a preferred embodiment, one or more of the platinum layers can include porous platinum and can have a thickness less than about 100 nm. Preferably, one or more of the platinum layers is deposited by ALD. Alternatively or additionally, one or more the platinum layers is deposited by DC/RF sputtering, chemical vapor deposition, pulse laser deposition, molecular beam epitaxy, evaporation, or any combination thereof.

The present invention is also directed to a SOFC including a cermet layer deposited between one or more electrode layers and an electrolyte layer. It is important to note that the thickness of the cermet layer ranges from about 1 angstrom to about 50 nm and is preferably deposited by atomic layer deposition (ALD). In a preferred embodiment, the cermet layer includes alternating metal and ceramic layers. The cermet layer can also include gradient compositional structures, including structures in which the thicknesses of the metal and/or ceramic layers depend on the position of the layers.

### BRIEF DESCRIPTION OF THE FIGURES

The present invention together with its objectives and advantages will be understood by reading the following description in conjunction with the drawings, in which:

FIG. 1 shows an example solid oxide fuel cell (SOFC) including an electrode/electrolyte interfacial layer according to the present invention.

FIG. 2 shows an example SOFC including an interfacial layer at two of the electrode/electrolyte interfaces according to the present invention.

FIG. 3 shows an example SOFC including an interfacial layer with alternating material layers according to the present invention.

FIG. 4 shows a plot of the impedance for example SOFCs according to the present invention.

FIG. 5 shows an example SOFC including an interfacial layer with a gradient structure according to the present invention.

FIG. 6 shows an example SOFC including an interfacial layer with another gradient structure according to the present invention.

FIG. 7 shows an example electrolyte layer including alternating material layers according to the present invention.

FIG. 8 shows an example electrolyte layer including gradient structure of alternating material layers according to the present invention.

FIG. 9 shows an example SOFC including an interfacial layer and ultra-thin film platinum layers according to the present invention.

FIG. 10 shows an example SOFC including a cermet layer at the interface of the electrolyte layer and the electrode layer according to the present invention.

FIG. 11 shows an example SOFC including a cermet layer with gradient structure according to the present invention.

### DETAILED DESCRIPTION OF THE INVENTION

The power density of a solid oxide fuel cell (SOFC) is determined, at least in part, by the electrical resistances at the junction of the electrodes and the electrolyte. Numerous factors contribute to the electrical resistance at an electrode/electrolyte interface, including density of electrons, density of vacancies, electron mobility, and ion mobility. The present invention is directed to a SOFC with an electrode/electrolyte interfacial layer for vacancy density control and decreased electrical resistance. In particular, the high performance of the SOFC of the present invention allows for adequate operation at intermediate and low temperatures, such as temperatures ranging between about 35° C. and about 45° C.

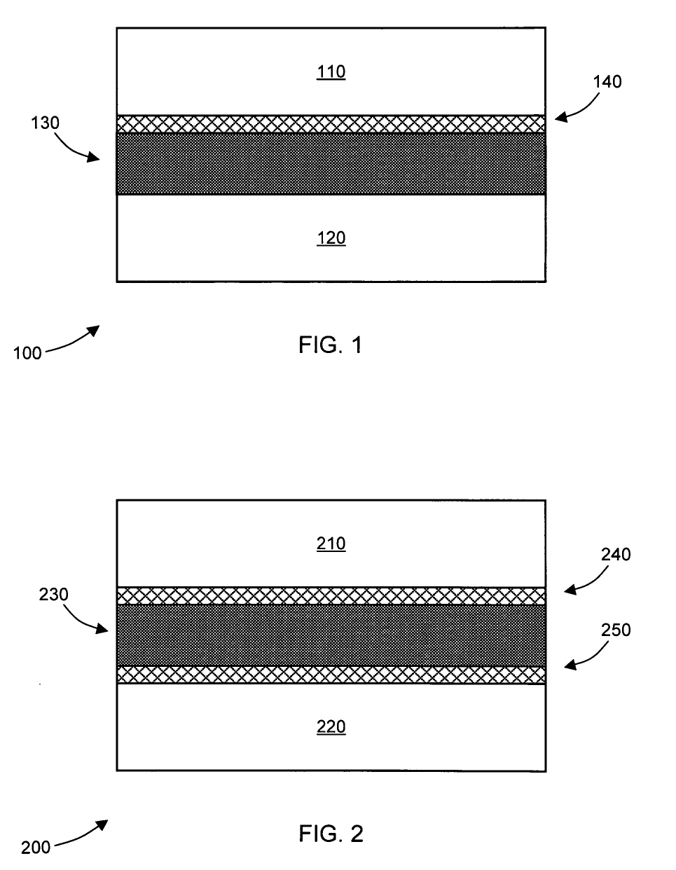

FIG. 1 shows an example SOFC 100 according to the present invention. It is noted that the components of all fuel cells shown in the figures are not drawn to scale. The SOFC 100 includes at least two electrode layers, a cathode layer 110 and an anode layer 120. The electrode layers can include an electric conductor, a metal, such as Pt, Ag, and Ni, a mixed ionic electronic conducting (MIEC) oxide, a catalyst/electrolyte catalyst, or any combination thereof. The SOFC 100 also includes an electrolyte layer 130, positioned between the cathode layer 110 and the anode layer 120. Generally, oxygen reduction occurs at or near the interface of the cathode layer 110 and the electrolyte layer 130 and vacancies near this interface are necessary to drive the oxygen ions across the electrolyte layer 130.

The SOFC 100 shown in FIG. 1 also includes an interfacial layer 140 deposited in the interface of any of the electrode layers and the electrolyte layer 130. In a preferred embodiment, the interfacial layer 140 is positioned between the cathode layer 110 and the electrolyte layer 130. The interfacial layer 140 includes an ion-conductive material, such as yttria-stabilized zirconia (YSZ) and scandia-stabilized zirconia (ScSZ). In addition, the interfacial layer 140 can include ceria-based oxides, such as gadolinia-doped ceria (GDC), yttria-doped ceria (YDC), samaria-doped ceria (SDC), or other ion oxide conductors. The interfacial layer 140 can also include a doped ion-conductive material. The electrolyte layer 130 can include the same or different ion-conductive material as the interfacial layer 140.

It is important to note that the interfacial layer 140 is preferably deposited by atomic layer deposition (ALD). By using ALD, the thickness of the interfacial layer 140 can be controlled down to approximately atomic-sized precision. In particular, in an embodiment of the present invention, the thickness of the interfacial layer 140 ranges from about 1 angstrom to about 50 nm. In a preferred embodiment, the thickness of the interfacial layer 140 ranges from about 1 angstrom to about 10 angstroms. These small thicknesses provide reduced electrical resistance across the interfacial layer 140. In an alternative embodiment, the interfacial layer 140 is deposited by DC/RF sputtering, chemical vapor deposition, pulse laser deposition, molecular beam epitaxy, or evaporation.

In a preferred embodiment, the electrolyte layer 130 and the interfacial layer 140 include a doped ion-conductive material, however the doping of the ion-conductive material in the electrolyte layer 130 may differ from the doping of the material in the interfacial layer 140. In particular, the doping the doped ion-conductive material of the interfacial layer 140 is greater than or equal to the doping of the doped ion-conductive oxide material of the electrolyte layer 130. In an exemplary embodiment, the doped ion-conductive oxide material is YSZ, the doping of the YSZ of the electrolyte layer 130 is about 8% yttria, and the doping of the YSZ of the interfacial layer 140 ranges between about 8% yttria to about 20% yttria.

In certain embodiments of the present invention, a SOFC can include another electrode/electrolyte interfacial layer. FIG. 2 shows a SOFC 200 including a cathode layer 210, an anode layer 220, an electrolyte layer 230, a cathode/electrolyte interfacial layer 240, and an anode/electrolyte interfacial layer 250. In an embodiment, the cathode/electrolyte interfacial layer 240, the electrolyte layer 230, and the anode/electrolyte interfacial layer 250 all include a doped ion-conductive material. However, the doping of the material in each layer can be different from the material in other layers.

In a preferred embodiment, the doping in the cathode/electrolyte interfacial layer 240 is greater than or equal to the doping in the electrolyte layer 230 and the doping in the electrolyte layer 230 is greater than or equal to the doping in the anode/electrolyte interfacial layer 250. In particular, the interfacial and electrolyte layers can include YSZ, with doping ranging from about 8% yttria to about 20% yttria, about 8% yttria, and ranging from about 0.1% yttria to about 8% yttria for the cathode/electrolyte interfacial layer 240, the electrolyte layer 230, and the anode/electrolyte 250 interfacial layer, respectively.

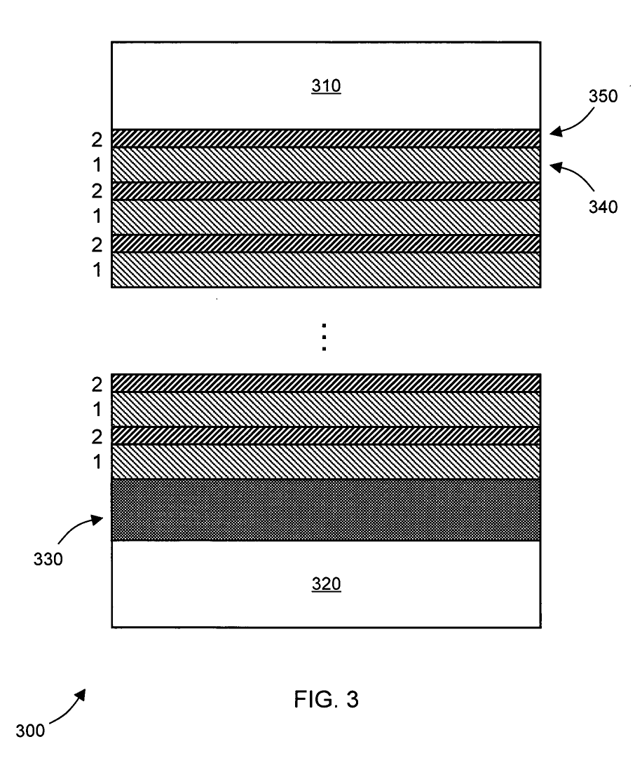

FIG. 3 shows an embodiment of a SOFC 300 including a cathode layer 310, an anode layer 320, an electrolyte layer 330, and an interfacial layer with alternating first 340 and second 350 material layers. Though the interfacial layer is shown in FIG. 3 to be located at the cathode/electrolyte interface, an interfacial layer can be alternatively or additionally positioned between the electrolyte layer 330 and the anode layer 320. The interfacial layer can include any number of first material layers 340 and any number of second material layers 350. The first 340 and second 350 material layers are alternately deposited, preferably by ALD. In a preferred embodiment, the first material layer 340 includes zirconia and the second material layer 350 includes yttria.

In the embodiment shown in FIG. 3, all of the first material layers 340 have approximately the same thickness. Similarly, all of the second material layers 350 have approximately the same thickness. In a preferred embodiment, the thickness of each of the first material layers 340 is greater than the thickness of each of the second material layers 350.

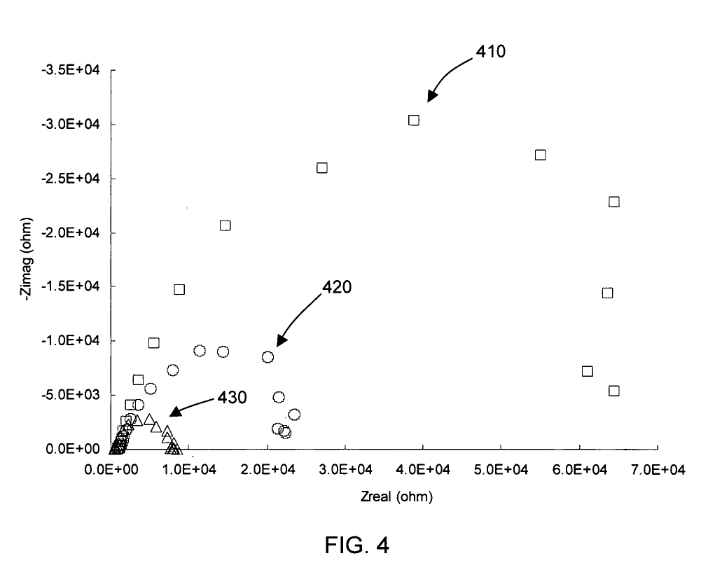

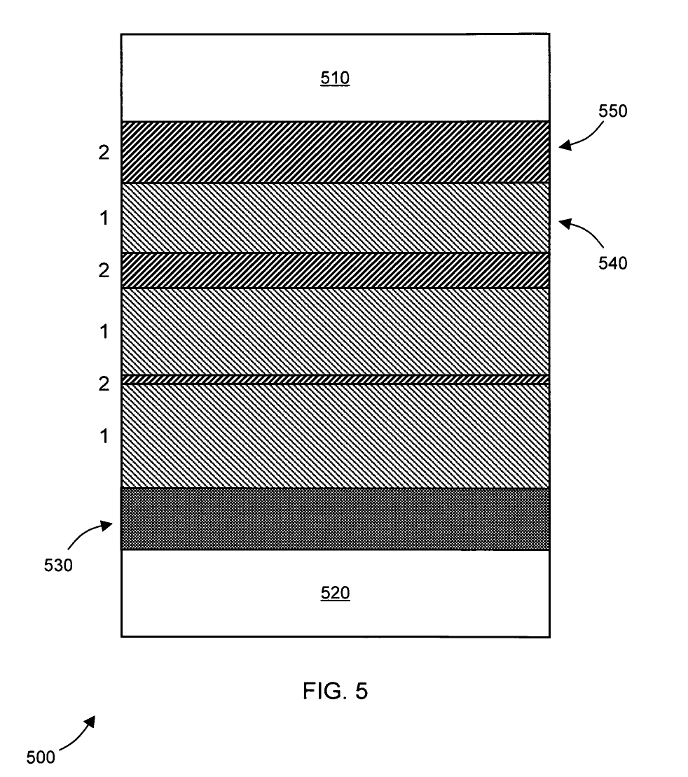

FIG. 4 shows impedance plots for three separate example devices. The vertical axis of the plot represents the imaginary part of the impedance Z, and the horizontal axis represents the real part of the impedance Z. The impedance is related to the electrical resistance. The data sets 410, 420, and 430 shows impedance measurements for SOFC devices having interfacial layers that include 8 ALD cycles of zirconia, 8 ALD cycles of yttria, and 7 ALD cycles of zirconia plus 1 ALD cycle of yttria, respectively. All devices have interfacial layers with thicknesses ranging from about 6 angstroms to about 11 angstroms. The plot, shown by FIG. 4, clearly shows that the device with mixed zirconia and yttria layers at the interface has the highest performance in terms of impedance.

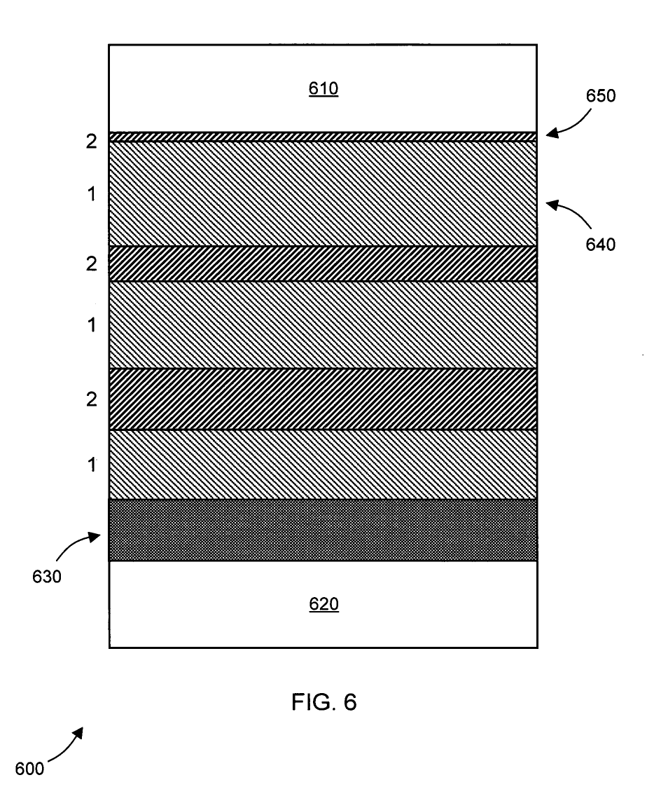

In certain embodiments, the interfacial layer of the SOFC includes alternating layers of a first and a second material, however, the thickness of the material layers may be non-uniform. Similar to the SOFC 300 of FIG. 3, FIG. 5 shows a SOFC 500 including a cathode layer 510, an anode layer 520, an electrolyte layer 530, and an interfacial layer with alternating first 540 and second 550 material layers. However, in contrast to SOFC 300, for SOFC 500, the thickness of each of the first material layers 540 depends on the position of the first material layer. Similarly, the thickness of each of the second material layers 550 depends on the position of the second material layer. By controlling the thickness of the first 540 and second 550 material layers, particularly by using ALD, the vacancy density through the interfacial layer can be controlled. Vacancy (and/or doping) gradient structures can be included in the SOFC. For example, when the first material layer includes zirconia and the second material layer includes yttria, the interfacial layer can include a gradient structure with varying amounts of yttria doping.

FIG. 5 and FIG. 6 show embodiments of SOFCs with gradient structures. In FIG. 5, the thickness of the first material layers 540 decreases with distance away from the electrolyte layer 530. In addition, the thickness of the second material layers 550 increases with distance away from the electrolyte layer 530. FIG. 6 shows an alternative embodiment of a SOFC 600 including an interfacial layer with alternating first 640 and second 650 material layers positioned between the cathode layer 610 and the electrolyte layer 630. In contrast to SOFC 500 of FIG. 5, in FIG. 6, the thickness of the first material layers 640 increases with distance away from the electrolyte layer 630. In addition, the thickness of the second material layers 650 decreases with distance away from the electrolyte layer 630.

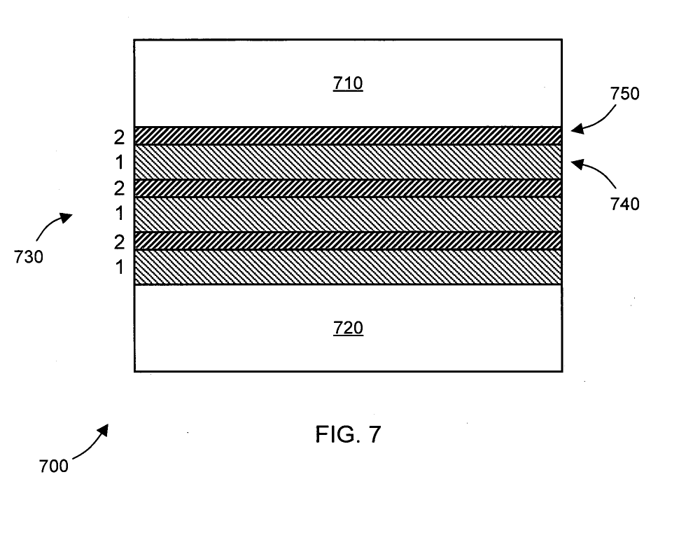

FIG. 7 shows an embodiment of a SOFC 700 including a cathode layer 710, an anode layer 720, and an electrolyte 730 positioned between the two electrode layers. In the embodiment shown in FIG. 7, the electrolyte 730 can be similar to the interfacial layer described in the preceding paragraphs. In particular, the electrolyte 730 includes one or more first material layers 740 and one or more second material layers 750. The first 740 and second 750 material layers alternate along the vertical direction. In an embodiment, the first material layer 740 includes zirconia and the second material layer 750 includes yttria. Preferably, a zirconia layer is directly adjacent to the anode layer 720 and an yttria layer is directly adjacent to the cathode layer 710. All layers of the electrolyte 730 can be deposited by ALD.

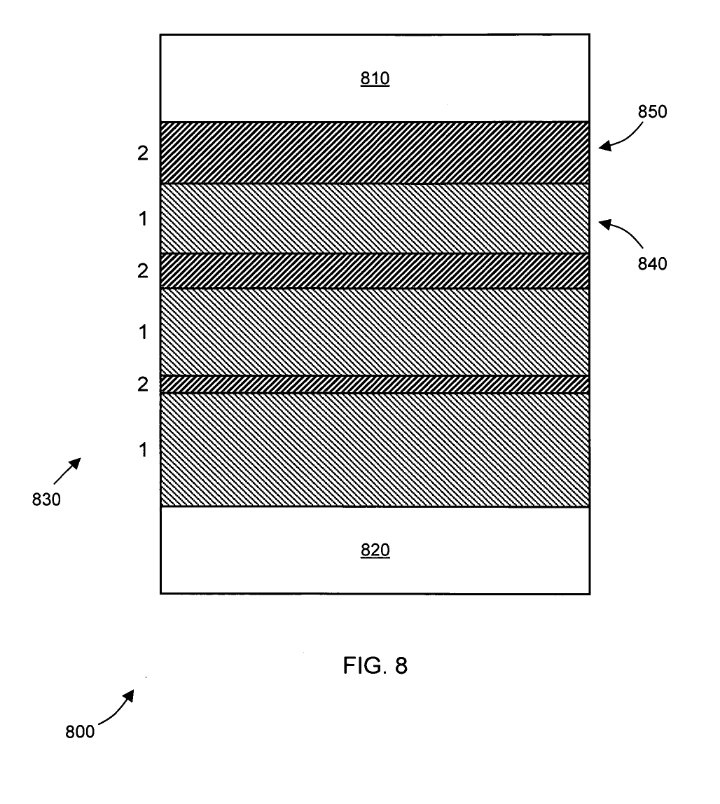

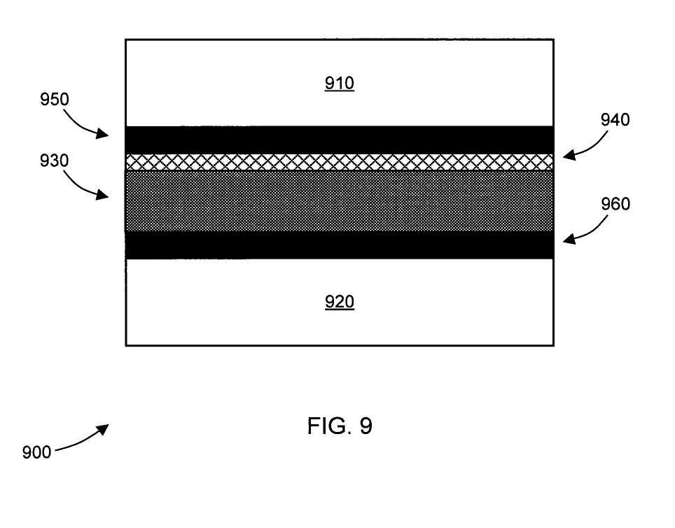

FIG. 8 shows an embodiment of a SOFC 800 including a cathode layer 810, an anode layer 820, and an electrolyte 830 with alternating first 840 and second 850 material layers. Similar to the interfacial layers shown in FIGS. 5 and 6, the electrolyte 830 of FIG. 8 can have gradient structures. More generally, the thickness of each of the first material layers 840 can depend on the position of the first material layers 840 and/or the thickness of each of the second material layers 850 can depend on the position of the second material layers 850. An exemplary embodiment of a SOFC 900 of the present invention is shown in FIG. 9. Similar to the embodiments described above, SOFC 900 includes a cathode layer 910, an anode layer 920, an electrolyte layer 930, and an interfacial layer 940. In addition, one or more ultra-thin film platinum layers 950 and 960, can be positioned between the electrolyte layer 930 and one or more of the electrode layers. In a preferred embodiment, an ultra-thin film platinum layer 950 of porous platinum is positioned between the interfacial layer 940 and an electrode layer, such as the cathode layer 910.

It is important to note that one or more of the platinum layers have a thickness less than about 100 nm. The small thickness provides a SOFC with short gas diffusion paths to ensure sufficient gas (oxidant or fuel) to reach the reaction zones at high loading. The high loading allows for a high current density before starvation of oxygen and/or fuel gases. Preferably, one or more of the platinum layers are deposited by atomic layer deposition. Alternatively, one or more of the platinum layers are deposited by DC/RF sputtering, chemical vapor deposition, pulse laser deposition, molecular beam epitaxy, evaporation, or any combination thereof.

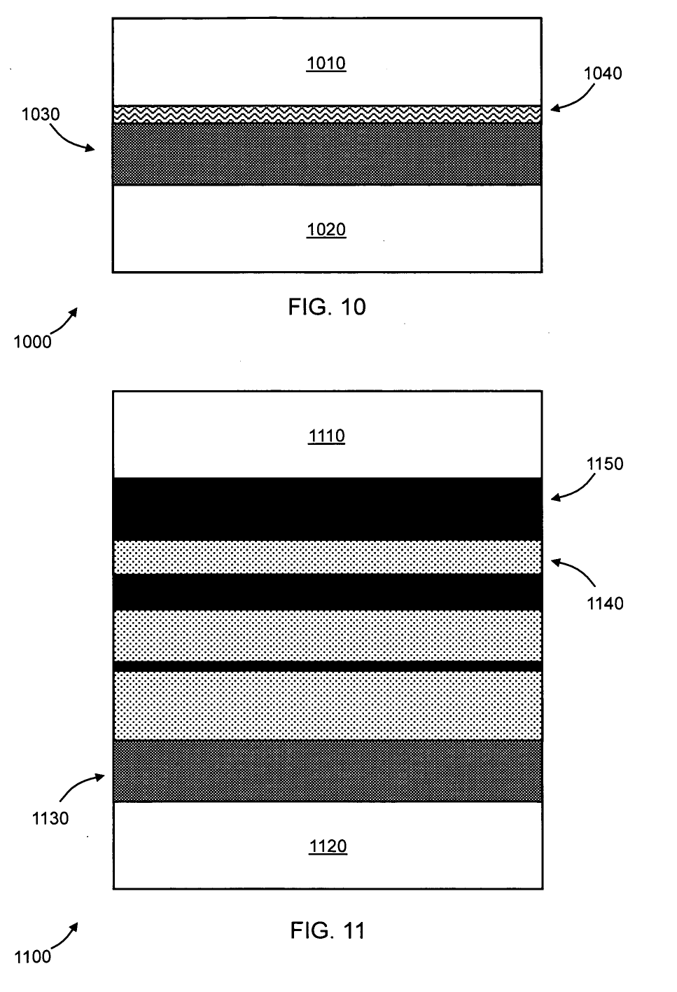

FIGS. 10 and 11 show other embodiments of the present invention related to cermet structures in a SOFC. The SOFC 1000, shown in FIG. 10, includes electrodes 1010-1020, an electrolyte layer 1030, and a cermet layer 1040. The cermet layer 1040 can be positioned at the interface between the electrolyte layer 1030 and the cathode layer 1010, the anode layer 1020, or both of the electrode layers. In certain embodiments, a SOFC can include a cermet layer 1040 in combination with or in replacement of an interfacial layer, such as the ion-conductive interfacial layers shown in FIG. 1.

It is important to note that the cermet layer 1040 is ultra-thin. In a preferred embodiment, the cermet layer 1040 has a thickness ranging from about 1 nm to about 50 nm. Furthermore, the cermet layer 1040 is preferably deposited by atomic layer deposition. The cermet layer 1040 can also include alternating layers of a ceramic material and a metal, such as platinum, ruthenium, silver, and nickel.

FIG. 11 shows a preferred embodiment of the cermet layer having a gradient structure with alternating layers. The SOFC 1100 includes alternating metallic layers 1150 and ceramic layers 1140 positioned between an electrode, such as the cathode 1110 or the anode 1120, and an electrolyte layer 1130. The combined metallic 1150 and ceramic 1140 layers can include changing ratios of metal to ceramic to form gradient structures. In certain embodiments, the thickness of each of the metallic layers 1150 and/or each of the ceramic layers 1140 depend on the position of the layers. Particularly, FIG. 11 shows metallic layers 1150, such as platinum layers, with thicknesses increasing with distance away from the electrolyte layer 1130. The ceramic layers 1140 can have the same or the opposite thickness dependence with the distance away from the electrolyte layer 1130.

As one of ordinary skill in the art will appreciate, various changes, substitutions, and alterations could be made or otherwise implemented without departing from the principles of the present invention, e.g. alternative materials and fuel cell geometries can be used. Accordingly, the scope of the invention should be determined by the following claims and their legal equivalents.

What is claimed is:

1. A solid oxide fuel cell comprising:
(a) at least two electrode layers, wherein one of said electrode layers is a cathode layer, and wherein another of said electrode layers is an anode layer;
(b) an electrolyte layer, wherein said electrolyte layer is positioned between said anode layer and said cathode layer; and
(c) an interfacial layer, wherein said interfacial layer is deposited between one of said electrode layers and said electrolyte layer, wherein said interfacial layer comprises an ion-conductive material, wherein the thickness of said interfacial layer ranges from about 1 angstrom to about 50 nm, and wherein said interfacial layer is deposited by atomic layer deposition.

2. The solid oxide fuel cell as set forth in claim 1, wherein said interfacial layer is positioned between said cathode layer and said electrolyte layer, wherein said electrolyte layer and said interfacial layer comprise a doped ion-conductive oxide material, and wherein the doping of said doped ion-conductive oxide material of said interfacial layer is greater than the doping of said doped ion-conductive oxide material of said electrolyte layer.

3. The solid oxide fuel cell as set forth in claim 2, wherein said doped ion-conductive oxide material comprises yttria-stabilized zirconia (YSZ), wherein the doping of said YSZ of said electrolyte layer is about 8% yttria, and wherein the doping of said YSZ of said interfacial layer ranges from about 8% yttria to about 20% yttria.

4. The solid oxide fuel cell as set forth in claim 2, further comprising an anode/electrolyte interfacial layer positioned between said anode layer and said electrolyte layer.

5. The solid oxide fuel cell as set forth in claim 4, wherein said anode/electrolyte interfacial layer comprises said doped ion-conductive oxide material, and wherein the doping of said doped ion-conductive oxide material of said anode/electrolyte interfacial layer is less than the doping of said doped ion-conductive oxide material of said electrolyte layer.

6. The solid oxide fuel cell as set forth in claim 5 wherein said doped ion-conductive oxide material of said anode/electrolyte interfacial layer comprises yttria-stabilized zirconia (YSZ), wherein the doping of said YSZ of said electrolyte layer is about 8% yttria, wherein the doping of said YSZ of said anode/electrolyte interfacial layer ranges from about 0.1% yttria to about 8% yttria.

7. The solid oxide fuel cell as set forth in claim 1, wherein said interfacial layer comprises one or more first material layers and one or more second material layers, and wherein said first material layers and said second material layers are alternately deposited between said electrolyte layer and one of said electrode layers.

8. The solid oxide fuel cell as set forth in claim 7, wherein said first material layer comprises zirconia, and wherein said second material layer comprises yttria.

9. The solid oxide fuel cell as set forth in claim 7, wherein the thickness of each of said first material layers is greater than the thickness of each of said second material layers.

10. The solid oxide fuel cell as set forth in claim 7, wherein the thickness of each of said first material layers depends on the position of the same of said first material layers, and wherein the thickness of each of said second material layers depends on the position of the same of said second material layers.

11. The solid oxide fuel cell as set forth in claim 10, wherein the thickness of said first material layers decreases with the distance away from said electrolyte layer, the thickness of said second material layers increases with the distance away from said electrolyte layer, or the thickness of said first material layers decreases and the thickness of said second material layers increases with distance away from said electrolyte layer.

12. The solid oxide fuel cell as set forth in claim 10, wherein the thickness of said first material layers increases with the distance away from said electrolyte layer, the thickness of said second material layers decreases with the distance away from said electrolyte layer, or the thickness of said first material layers increases and the thickness of said second material layers decreases with distance away from said electrolyte layer.

13. The solid oxide fuel cell as set forth in claim 1, further comprising a first ultra-thin film platinum layer, wherein said first platinum layer is positioned between said interfacial layer and one of said electrode layers.

14. The solid oxide fuel cell as set forth in claim 13, wherein said first platinum layer has a thickness less than about 100 nm, and wherein said first platinum layer comprises porous platinum.

15. The solid oxide fuel cell as set forth in claim 13, wherein said first platinum layer is deposited by atomic layer deposition.

16. The solid oxide fuel cell as set forth in claim 13, further comprising a second ultra-thin film platinum layer, wherein said second platinum layer is positioned between said electrolyte layer and another of said electrode layers.

17. The solid oxide fuel cell as set forth in claim 1, wherein the thickness of said interfacial layer ranges from about angstrom to about 10 angstroms.

18. The solid oxide fuel cell as set forth in claim 1, wherein said interfacial layer comprises a ceria-based oxide.

19. A solid oxide fuel cell comprising:
(a) at least two electrode layers, wherein one of said electrode layers is a cathode layer, and wherein another of said electrode layers is an anode layer;
(b) an electrolyte layer, wherein said electrolyte layer is positioned between said anode layer and said cathode layer; and
(c) a cermet layer, wherein said cermet layer is deposited between one of said electrode layers and said electrolyte layer, wherein said cermet layer comprises an cermet material, wherein the thickness of said cermet layer ranges from about 1 angstrom to about 50 nm, and wherein said cermet layer is deposited by atomic layer deposition.

20. The solid oxide fuel cell as set forth in claim 19, wherein said cermet layer comprises one or more metal layers and one or more ceramic layers, and wherein said metal layers and said ceramic layers are alternately deposited between said electrolyte layer and one of said electrode layers.
